(19) United States
(12) Patent Application Publication
(10) Pub. No.: US 2026/0267444 A1
(43) Pub. Date: Sep. 10, 2026

(54) DISPLAY WITH INTEGRATED SENSORS AND SYSTEMS AND METHODS RELATED THERETO

(71) Applicant: ams-OSRAM AG, Premstaetten (AT)

(72) Inventors: Julius Komma, Jena (DE); Dan Jacobs, Hitzendorf (AT); Rainer Minixhofer, Premstätten (AT)

(21) Appl. No.: 18/873,594

(22) PCT Filed: Jun. 19, 2023
(86) PCT No.: PCT/EP2023/066446

§ 371 Date: Dec. 10, 2024

Related U.S. Application Data
(60) Provisional application No. 63/353,556, filed on Jun. 18, 2022.

(51) Int. Cl. G06F 3/042; G06F 3/041; G06V 40/13

(52) U.S. Cl. CPC G06F 3/0421; G06F 3/0412; G06V 40/1318

(57) ABSTRACT

A system including a display having a combination of display pixels and sensors integrated in the display. The pixels of the display may be configured to produce a display image, and the integrated sensors may be configured to sense objects touching, or in proximity to, the display by detecting light emitted by the pixels and reflected to the integrated sensors. The outputs of the sensors may be provided to one or more controllers for operating a function of the system, e.g., controlling one or more features of the system.

### CROSS-REFERENCE TO RELATED APPLICATION

The application claims the benefit of the filing date of U.S. Provisional Application Ser. No. 63/353,556, filed Jun. 18, 2022, the entire teachings of which are hereby incorporated herein by reference.

### TECHNICAL FIELD

The present application relates to a display for an electronic device, and more particularly, to a display including integrated sensors and systems and methods related thereto.

### BACKGROUND

A typical display or screen for electronic devices such as mobiles phones, tablets, computers, televisions, smart watches, and the like, as known in the art, uses conventional display technology including light emitting diodes (LED), organic light emitting diodes (OLED), polymer light emitting diodes (PLED), etc., to display images. Some displays may be configured to permit users to interact with the display and associated software. The user interaction may be direct, e.g., through use of a touch display or touch screen, or indirect, e.g., though use of an input device such as a mouse, a stylus, a keyboard, a controller, etc.

Often interactive displays are incapable of discerning specific features of an object, e.g., a user's finger, a stylus, etc., that comes in contact therewith. Electronic devices capable of discerning features of an object in contact therewith include fingerprint readers and sensors, which are well known in the art. Examples of fingerprint readers are described in published U.S. Patent Application Nos. 2013/0287272A1, 2011/0300829A1, 2011/0254771A1, and 2022/0068900A1, among many others. Known fingerprint readers are typically dedicated hardware devices that are able to read a single finger and, in some versions, perform certain actions (e.g., on a mobile phone to go back in an application). Other conventional fingerprint readers use software to place a fingerprint reader at a certain location on a display screen and, when the user's finger touches that particular location, one or more actions may be performed.

### BRIEF DESCRIPTION OF THE DRAWINGS

Objects, features, and advantages disclosed herein will be apparent from the following description of particular embodiments, as illustrated in the accompanying drawings in which like reference characters/descriptions refer to the same parts throughout the different views. The drawings are not necessarily to scale, emphasis instead being placed upon illustrating the principles disclosed herein. For purposes of clarity, not every component may be labeled in every drawing.

FIG. 1 is a simplified block diagram of one example embodiment of a system consistent with the present disclosure.

FIG. 2 diagrammatically illustrates a plan view of one example of a display consistent with the present disclosure with a portion of the display shown in magnified view.

FIG. 3 diagrammatically illustrates a plan view of one example of a pixel and an associated sensor of the display shown in FIG. 2.

FIG. 4 diagrammatically illustrates a plan view of another example of a pixel and an associated sensor consistent with the present disclosure.

FIG. 5 diagrammatically illustrates a plan view of one example of a pixel and multiple associated sensors consistent with the present disclosure.

FIG. 6 diagrammatically illustrates a sectional view of one example of a portion of a display consistent with the present disclosure.

FIG. 7. is a flowchart illustrating operations of one example of a method consistent with the present disclosure.

FIG. 8 is a simplified block diagram of one example of a controller consistent with the present disclosure.

FIG. 9 diagrammatically illustrates a sectional view of one example of a portion of a display for detecting a finger consistent with the present disclosure.

FIG. 10 diagrammatically illustrates one example of user operation of a function of a system consistent with the present disclosure using a single finger.

FIG. 11 diagrammatically illustrates another example of user operation of a function of a system consistent with the present disclosure using a single finger.

FIG. 12 diagrammatically illustrates one example of user operation of a function of a system consistent with the present disclosure using two fingers.

FIG. 13 diagrammatically illustrates one example of user operation of a function of a system consistent with the present disclosure using motion of a single finger.

FIG. 14 diagrammatically illustrates one example of user operation of a function of a system consistent with the present disclosure using motion of two fingers.

FIG. 15 diagrammatically illustrates a sectional view of one example of a portion of a display for detecting orientation of a finger consistent with the present disclosure.

FIG. 16 diagrammatically illustrates a sectional view of one example of a portion of a display for detecting orientation of a finger consistent with the present disclosure.

FIG. 17 diagrammatically illustrates a sectional view of one example of a portion of a display for detecting an object consistent with the present disclosure.

FIG. 18 diagrammatically illustrates a sectional view of one example of a portion of a display for detecting an object consistent with the present disclosure using illumination patterns.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

Conventional techniques for interacting with a display, such as those described above, include a variety of limitations. Conventional touch screen displays configured for reading a fingerprint, for example, employ either a hardware-based fingerprint sensor to read a user's fingerprint, and then activate certain functionality, or a software-based fingerprint sensor that is limited to a certain location on the display. Some conventional technologies permit the location of this software-based sensor to be changed, but the user must then remember where the software-based sensor is located and/or the device must remind the user of the location. This slows down the user's interaction with the display and makes it less intuitive.

Additionally, conventional displays relying upon capacitive technology cannot read a more precise part of a finger, such as a fingernail. It may be possible to use a finger to interact with the display, but in many instances a finger may be too large to offer the precision needed. In order to have precise interactions with a display, a stylus or other separate input device may be used. Unfortunately, a stylus or other input device usually provides only a single associated functionality. To provide additional functionality, a complicated and thus more power-intensive and costly stylus (including, for example, multiple buttons that may be interacted with in different ways, requiring batteries that must be changed) is needed. Also, conventional displays relying on capacitive technology require physical touching of the display to sense or read an object, and do not operate when a finger or other object is in proximity to the display, but not touching the display.

In embodiments consistent with the present disclosure an electronic device includes a display having a combination of display pixels and sensors integrated in the display. The display may be a display used for any electronic device including, but not limited to, a mobile phone, a tablet, a computer, a television, a smart watch, or the like. The pixels of the display may be configured to produce a display image in a known fashion, and the integrated sensors may be configured to sense objects touching, or in proximity to, the display from light emitted by the pixels and reflected by the object. The outputs of the sensors may be provided to a controller for operating a function of the device, e.g., launching an application or modifying, adjusting, or controlling one or more features of the electronic device.

For example, embodiments of the present invention provide a combination of microLEDs and sensors integrated in the display to enable a variety of display interface applications for devices that currently utilize or could utilize a touch screen. MicroLED displays allow for an easy integration of sensors into the display due to the very small size of the microLEDs providing enough space between the clusters of microLEDs for sensors. Additionally, it is possible to add various sensors, including but not limited to photosensors and the like, into the same layer as the microLEDs without influencing the display. More specifically, it is possible to add such components in the same plane as the microLEDs and correspondingly to improve performance of the display. This may be further optimized by using a special filter or other similar device on the cover material for the display (e.g., glass, plastic, etc.). Additionally, adding such microLEDs, which are not visible to a user, mean that the user does not need to be aware of the display technology in order to interact with it (i.e., the process is effectively invisible to the user).

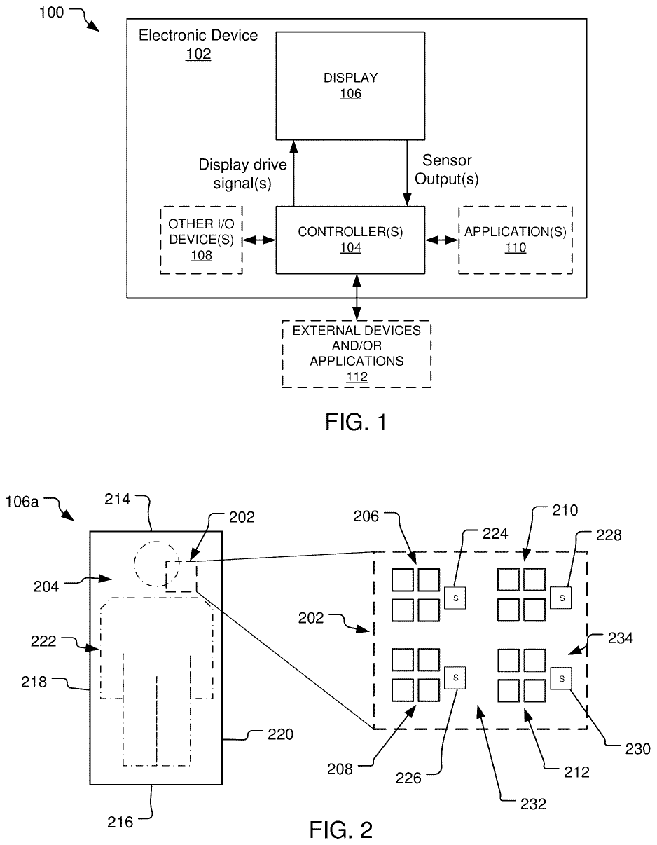

FIG. 1 is a block diagram of one example of a system 100 consistent with the present disclosure. The system 100 is depicted in highly simplified form for ease of explanation. Those of ordinary skill in the art will recognize that the system may include components in addition to the depicted components, e.g., power supply components, and the illustrated components may be provided in a variety of configurations.

The illustrated example system 100 includes an electronic device 102. The electronic device 102 includes at least one controller 104 and a display 106. The display 106 may produce an image visible to a user on a screen thereof in a known manner. For example, the display 106 may include a plurality of pixels, e.g., arranged in a two-dimensional gid. Each of the pixels may, for example, include a combination of red, green, and blue subpixels, that may be driven to emit light at different intensities through a screen of the display 106 to produce a desired combined light output color for the pixel to produce the image.

Each pixel may have a logical address and the controller(s) 104 may be configured, in a known manner, to provide one or more display drive signal(s) for separately driving each pixel. The display drive signal(s) may be digital signals, e.g., including a byte of data for each of the red, green, and blue subpixels, to specify the color of the combined light emitted by the pixel. The controller(s) 104 provides the display drive signal(s) to produce a dynamic and/or still image that is visible through a screen, e.g., a top surface, of the display 106.

The individual pixels may be backlit or self-emitting. In some embodiments, the display 106 may be configured as a liquid crystal display (LCD). As is known, in an LCD display the pixels are illuminated using light emitting diode (LED) backlights. In some embodiments, the display 106 may be configured as an organic light-emitting diode (OLED) display As is known, in an OLED display the pixels are self-emitting and do not require a backlight.

The display 106 may include any number and arrangement of pixels. In embodiments, the number and arrangement of pixels in the display 106 may be chosen to achieve a desired display resolution. The pixels may provide a resolution of, for example, about 100-500 pixels-per-inch (ppi). In some embodiments, for example, the pixels may be arranged in a two-dimensional grid, given as (the number of horizonal pixels)×(the number of vertical pixels), such as 640×480, 1280×720, 2550×1440 or 3840×2160.

In a system consistent with the present disclosure, the display 106 further includes a plurality of sensors (not shown), examples of which are described herein. Each of the sensors is configured to detect light emitted by one or more of the pixels through a screen (e.g., a top surface) of the display 106 and reflected by an object in contact with, or adjacent to, the display 106 and back through the screen of the display 106. Each of the sensors may be any device or combination of devices configured to produce an electrical output representative of the intensity of the light imparted thereon, and may include for example a known photodetector, such as a photodiode (PD).

Each sensor may have an associated logical address and the output of each sensor is coupled to the controller(s) 104 as one or more sensor output(s). The controller(s) 104 is (are) configured to receive the sensor output(s) from the sensors and operate a function of the system 100 in response to the sensor outputs(s). As used herein, the phrase “operate a function” means to launch a function, enable a feature of a function, adjust a feature of a function, and/or modify a feature of a function. For example, in embodiments the controller(s) 104 may be configured to provide display drive signal(s) to operate the display function of the electronic device 102 by modifying the image produced by the display 106 in response to the sensor output(s).

In embodiments, the controller(s) 104 may be coupled to one or more other input/output (I/O) devices 108, such as a speaker, microphone, haptic device such as but not limited to a keyboard, a keypad, a printer, a digital camera, and/or other suitable devices, and may be configured to operate a function of one or more of the I/O devices 108, e.g., by adjusting adjust the volume of a speaker, enabling a microphone, printing a document, etc. In embodiments, the controller(s) 104 may be configured to operate a function of one or more applications 110, e.g., stored in the electronic device 102, such as a word processing application, a mobile phone application, etc., and may be configured to launch the one or more applications 110, e.g., a music application or a social media application.

The system 100 may optionally include one or more external devices and/or applications 112 that are external to the electronic device 102. The external devices and/or applications 112 may be coupled to the electronic device 102 through one or more networks. The one or more networks may include any number and/or combination of local area networks (LANs, including BLUETOOTH®; Near Field Communication/NFC, ZIGBEE®, and similar); wireless local area networks (WLANs); cellular networks; wide area networks (WANs); and/or worldwide area networks (WWANs, such as the Internet). Examples of external devices and/or applications 112 include an output device such as a printer or a speaker, a vehicle, a robot, a remote security monitoring system, a cloud-based software application, etc. In embodiments, the controller(s) 104 may be configured to operate a function of the external devices and/or applications 112 in response to the sensor output(s), e.g., to print a selected image, to control a vehicle, to control a robot, to view alerts or video from a remote monitoring system, etc.

FIG. 2 diagrammatically illustrates one example of a display 106a consistent with the present disclosure with an area 202 of a screen 204 of the display 106a diagrammatically illustrated in magnified view. In the illustrated example of FIG. 2, the magnified portion of the display 106a includes four pixels 206, 208, 210, 212. The pixels 206, 208, 210, 212 are arranged in a 2×2 grid including two rows and two columns. The pixels 206, 208, 210, 212 may be part of a larger two-dimensional grid of pixels, e.g., encompassing the entire screen 204 of the display 106a extending between a top 214 and bottom 216 and a left 218 and right 220 sides of the display 106a.

Each of the pixels 206, 208, 210, 212 may be configured to emit light that contributes to an image, e.g., an image 222, produced by the display 106a, and has an associated sensor 224, 226, 228, 230 positioned adjacent thereto. The sensors 224 and 226 are disposed in a space 232 between the two columns of pixels. The sensors 228 and 230 may also be disposed in a space 234 between adjacent columns (not shown in the magnified portion of FIG. 2). Although the sensors 224, 226, 228, 230 are illustrated as being disposed in spaces between columns of pixels, in embodiments sensors, e.g., sensors 224, 226, 228, 230, may also, or alternatively, be placed in spaces between rows of pixels.

The sensor 224, 226, 228, 230 associated with each pixel 206, 208, 210, 212, respectively, may be configured to detect light emitted from the pixel 206, 208, 210, or 212 associated therewith and reflected from an object adjacent the display 106a and back into the screen 204 of the display 106a. An object in contact with, or in proximity to, the screen 204 of the display 106a may be detected by one or more of the sensors 224, 226, 228, 230, which provide sensor output signals to the controller(s) 104 (shown in FIG. 1) for operating a function of the system 100. Although the illustrated example illustrates a single sensor 224, 226, 228, 230 associated with each pixel 206, 208, 210, 212, respectively, it is to be understood that any number of sensors may be associated with any one or more of the pixels 206, 208, 210, 212 or any group of the pixels 206, 208, 210, 212.

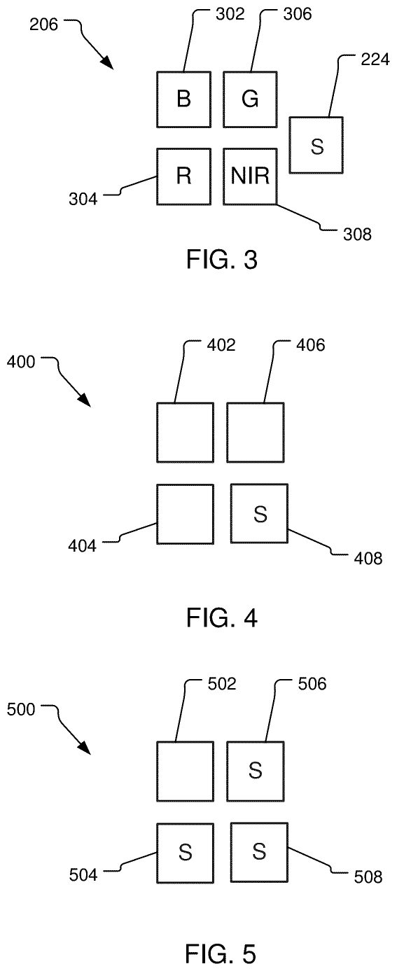

FIG. 3 illustrates the pixel 206 shown in the magnified portion of FIG. 2. In the illustrated example, the pixel 206 includes four subpixels 302, 304, 306, 308. The subpixels 302, 304, 306, 308 may be arranged in any configuration and may include any number of visible or invisible light sources. For example, in the illustrated embodiment the subpixels 302, 304, 306, 308 are arranged in a 2×2 grid with two columns and two rows. The subpixel 304 may emit having light a red (R) color, the subpixel 306 may emit light having a green (G) color, the subpixel 302 may emit light having a blue (B) color, to provide an RGB configuration for creating a combined light output of the pixel 206 having a desired color. As used herein, the term “color” generally is used to refer to a property of radiation that is perceivable by an observer. Accordingly, the term “different colors” implies two different spectra with different wavelength components and/or bandwidths. In addition, “color” may be used to refer to white and non-white light. The subpixel 308 may emit non-visible light, such as light in the near-infrared (NIR) spectrum.

Each subpixel that is configured to emit visible light, e.g., subpixels 302, 304, 306 may contribute to the image produced by the display 106a. Incorporating at least one subpixel 308 that emits non-visible light allows for the pixel 206 to detect objects when the pixel 206 is not emitting light to produce an image on the screen 204 of the display 106a. Also, in some embodiments, a subpixel 308 that emits non-visible light may be modulated to create a non-visible illumination pattern without a user being aware of the operation. Light emitted by one or more of the subpixels 302, 304, 306, 308 may be reflected from an object in contact with, or in proximity to, the display 106a and detected by the sensor 224.

Although the illustrated pixel 206 includes four subpixels 302, 304, 306, 308 with a specific arrangement of separate R, G and B subpixels and a single NIR subpixel, it is to be understood that a pixel in a display 106a consistent with the present disclosure may include any number (one or more) of subpixels, and the subpixels may emit visible or non-visible light in any combination depending on the desired image application for the display 106a. For example, each pixel may include one or more R, G, B and/or NIR subpixels. Each pixel may also, or alternatively, include, amber (A) and/or white (W) subpixels. In embodiments, each pixel may also, or alternatively, include one or more subpixels configured for color-tunable emissions. For example, each pixel may include one or more subpixels configured as a multi-color (e.g., bi-color, tri-color, etc.) semiconductor light source configured for a combination of emissions, such as: (1) red-green-blue (RGB); (2) red-green-blue-amber (RGBA); (3) red-green-blue-white (RGBW); (4) dual-white; and/or (5) a combination of any one or more thereof.

In embodiments consistent with the present disclosure, a sensor associated with one or more of the pixels may be positioned the same two-dimensional grid that includes the sub-pixels for the pixel. FIG. 4, for example, illustrates a pixel 400 including three-subpixels 402, 404, 406 each of which may emit non-visible light and/or visible light having an associated color (e.g., to provide an RGB combination) and an associated sensor 408. The three-subpixels 402, 404, 406 and the sensor 408 are provided in a 2×2 grid including two columns and two rows. The first column includes the subpixels 402 and 404 and the second column includes the subpixel 406 and the sensor 408.

FIG. 5 illustrates a pixel 500 including a single subpixel 502 that may emit non-visible light or visible light having one or more associated color(s) (e.g., a color tunable emission) and three associated sensors 504, 506, 508. The subpixel 502 and the sensors 504, 506, 508 are provided in a 2×2 grid including two columns and two rows. The first column includes the subpixel 502 and the sensor 504 and the second column includes the sensor 506 and the sensor 508.

With reference again to the example display 106a shown in FIG. 2, in embodiments consistent with the present disclosure, each sensor may be associated with a single pixel, or a group of pixels, and the sensors may be provided over the entirety of the screen 204 of the display 106a or a portion of the screen 204 of the display 106a. In some embodiments, for example, each pixel provided in the display 106a may have an associated sensor, e.g., positioned adjacent thereto and/or within the 2-dimensional grid of the pixel, whereby the sensors are positioned to detect light reflected by an object that is positioned over any portion of the screen 204 of the display 106a. The sensor associated with each pixel may be configured to detect light emitted from the pixel associated therewith and reflected from an object in contact with, or in proximity to, the screen 204 of the display 106a and back into the screen of the display 106a. In this configuration, an object in contact with, or in proximity to, any location on the screen 204 of the display 106a may be detected by one or more of the sensors to operate a function of the system.

In some embodiments, each of the pixels in a contiguous or collective portion of the display 106a may have an associated one of the sensors positioned adjacent thereto for detecting light emitted from the pixel and reflected back to the sensor. The contiguous portion of the screen 204 of the display 106a may be provided in regular or irregular geometric shape. The collective portion of the display 106a may include multiple separate contiguous portions spaced regularly or irregularly on the display. For example, sensors may be associated with an associated one of the pixels in contiguous or collective portion of the display 106a and may be positioned to detect light reflected by an object that is positioned over at least 90%, at least 80%, at least 70%, at least 60%, at least 50%, at least 40%, or at least 30% of the screen 204 of the display 106a.

In some embodiments, groups of pixels in the display 106a may have an associated one of the sensors positioned adjacent thereto. The groups of pixels may encompass the entire display 106a or a contiguous or collective portion of the display. The sensors may be positioned adjacent the groups of pixels to detect light reflected by an object positioned over any location of the display, at least 90%, at least 80%, at least 70%, at least 60%, at least 50%, at least 40%, or at least 30% of the screen 204 of the display 106 a. In some embodiments, a combination of groups of pixels with associated sensors and single pixels with associated sensors may encompass the entire display 106a or a contiguous or collective portion of the screen of the display.

In embodiments wherein a high-resolution display 106a is implemented and/or wherein the space between pixels in the display 106a may be limited by a desired form-factor for the device including the display 106a, the display 106a may be advantageously configured as a microLED (or μLED, or μ-LED) display 106a with pixels including one or more microLED subpixels. A microLED is an optoelectronic component, more specifically, a type of LED with very small edge lengths, typically less than 70 μm, especially down to less than 20 μm, and especially in the range of 1 μm to 10 μm or smaller. Another range is between 10 to 30 μm, and other ranges are known in the art. Despite their differences from conventional LEDs, microLEDs are also used in classic lighting devices and applications as well as displays. In displays, the microLEDs form pixels or subpixels and emit light of a defined color.

Using microLEDs, which may not be visible to a user, in the display 106a means that the user does not need to be aware of the display technology in order to interact with the display 106a (i.e., the process can be effectively invisible to the user). Also, using microLEDs in a display 106a consistent with the present disclosure allows for easy integration of sensors into the display 106a due to the very small size of the microLEDs. The small size of the microLEDs allows for enough space between the microLED(s) of each pixel for the sensor(s) associated with the pixel. Additionally, it is possible to mount the sensors in the same layer as the microLEDs without influencing the display.

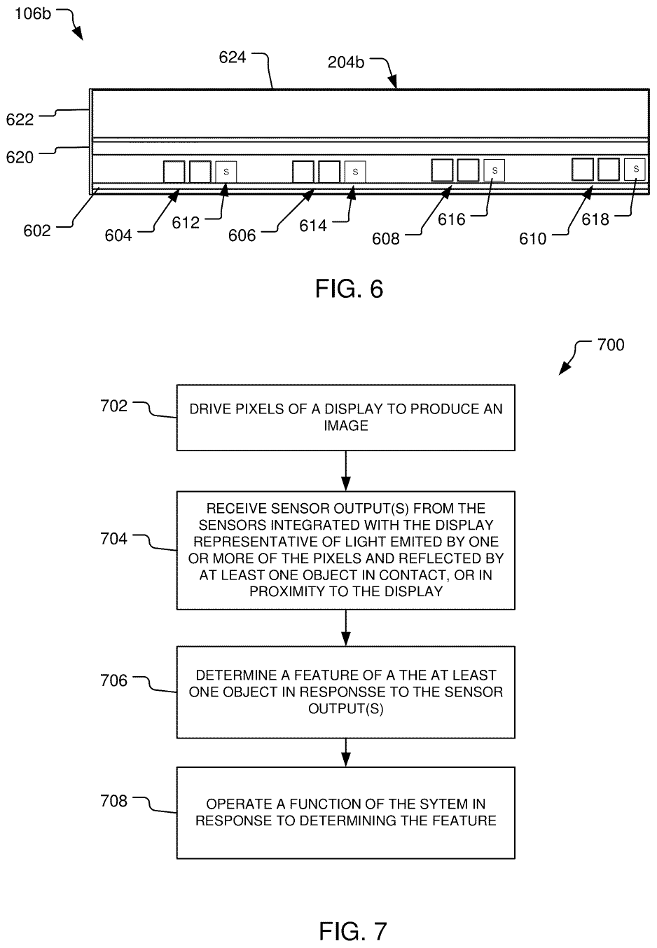

FIG. 6, for example, diagrammatically illustrates a cross-section of a portion of a display 106b consistent with the present disclosure. The illustrated example display 106b includes a base 602, a plurality of pixels 604, 606, 608, 610 mounted to the base 602, a sensor 612, 614, 616, 618 associated with each of the pixels 604, 606, 608, 610, respectively, and mounted to the base 602, an optional optics layer 620, and a cover layer 622.

The base 602 may be a printed circuit board configured for receiving the subpixels of each of the pixels 604, 606, 608, 610 and each of the sensors 612, 614, 616, 618 and coupling each of the pixels 604, 606, 608, 610 and the sensors 612, 614, 616, 618 to the controller(s) 104 (FIG. 1). The pixels 604, 606, 608, 610 may include microLED subpixels, e.g., in an arrangement as shown for example in FIG. 3, to provide spaces between the pixels 604, 606, 608, 610 for mounting the sensors 612, 614, 616, 618. The sensors 612, 614, 616, 618 may be mounted on the base 602 in the spaces between the pixels 604, 606, 608, 610 to be on the same plane as the pixels 604, 606, 608, 610 without interfering with the display 106b.

The optics layer 620 may be positioned over the base 602 and spaced therefrom to provide an area for the pixels 604, 606, 608, 610 and the sensors 612, 614, 616, 618 between the base 602 and the optics layer 620. The cover layer 622 is positioned over the optics layer 620. In the illustrated example, the top surface 624 of the cover layer 622 is the screen 204b of the display 106b.

Light emitted from pixels passes through the optional optics layer 620, and through the top surface of the cover layer 622 to produce an image on the screen 204b that is visible to a user. Light emitted from one or more of the pixels 604, 606, 608, 610 may be reflected from an object in contact with, or in proximity to, the top surface 624 of the cover layer 622, reflected back into the cover layer 622, and imparted on the sensors 612, 614, 616, 618. The sensors 612, 614, 616, 618 provide sensor output(s) representative of the presence of the object and/or features of the objects and the controller(s) 104 (FIG. 1) may operate a function of the system 100 (FIG. 1) in response to the sensor output(s).

The optional optics layer 620 and the cover layer 622 may each include an optical structure including any of a wide variety of transparent/translucent materials, such as, for example: a polymer, such as poly(methyl methacrylate) (PMMA) or polycarbonate; a ceramic, such as sapphire (Al2O3) or yttrium aluminum garnet (YAG); a glass; and/or any combination thereof. In embodiments, the optional optics layer 620 may include a sensor lens (not shown in FIG. 6) positioned over each of the sensors. Each of the sensor lenses may include an opaque portion and an aperture. The aperture may be configured to allow a portion of the light reflected back to the display 106b to be imparted on the sensor 612, 614, 616, 618, while the opaque portion may block a remainder of the reflected light from being imparted on the sensor 612, 614, 616, 618. For example, the aperture may allow only light reflected back to the display 106b within range of angles, or having a pre-defined polarization, to be imparted on the sensor 612, 614, 616, 618.

With reference again to FIG. 1, the controller(s) 104 may be provided in a variety of configurations. The controller(s) 104 may include any number (one or more) of controllers configured to perform the functions described herein, e.g., using software including computer readable program instructions, hardware, or any combination of software and hardware and may include a single controller or multiple controllers. Also, although the controller(s) 104 are illustrated in FIG. 1 as being included within the electronic device 102, one or more of the controller(s) 104 may be external to the electronic device 102 and coupled thereto by a wired or wireless connection.

Aspects of the controller(s) 104 for providing the display drive signal(s) to the display 106 for producing an image on a screen the display 106 may take a variety of configurations. For example, the controller(s) 104 may include a known processor coupled to a known display driver. Display driver configurations are well-known. In general, a display driver provides an interface between a processor and the display for providing display drive signal(s) to the pixels of the display for producing a desired imaged.

Aspects of the controllers(s) for operating a function of the system in response to the sensor output(s) may also take a variety of configurations. FIG. 7 is a flow chart 700 depicting operations of one example of the controller(s) 104 in a system 100 (FIG. 1) consistent with the present disclosure. It should be appreciated that embodiments of the present disclosure provide for operating a function of a system 100 in response to the sensor output(s) from sensors integrated with pixels in a display 106 (as shown, for example, in FIG. 1). FIG. 7 provides only an illustration of one implementation and does not imply any limitations with regard to the environments in which different embodiments may be implemented. Many modifications to the depicted environment may be made by those skilled in the art without departing from the scope of the disclosure as recited by the claims.

In the illustrated example embodiment 700, the controller(s) 104 drive(s) 702 the pixels of a display 106 to produce an image. The controller(s) 104 receive(s) 704 the sensor outputs(s) from the sensors integrated in the display. The sensor outputs are representative of light emitted by one or more of the pixels (to produce the image) and reflected by at least one object in contact with, or in proximity to, the display. The controller(s) 104 determine(s) 706 a feature of the at least one object in response to the sensor output(s). For example, the controller(s) 104 may identify the object as a finger, detect at least a portion of a fingerprint when the object is a finger, determine an orientation of the object relative to the display 106, etc. In response to determining the feature of at least one object, the controller(s) 104 operates(s) 708 a function of the system 100.

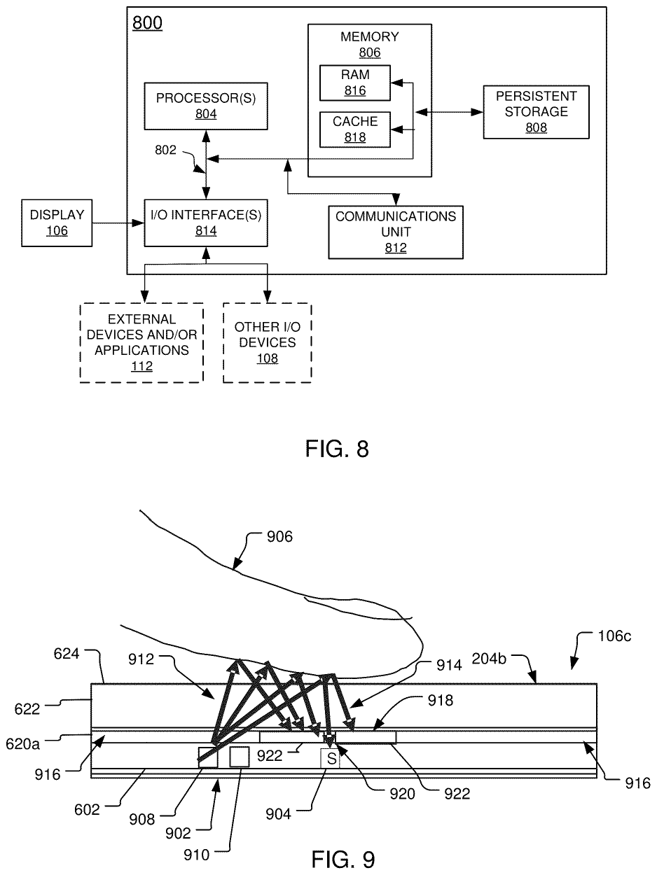

FIG. 8 is a block diagram depicting components of one example of aspects of the controller(s) 104 for operating a feature of the system in response to the sensor outputs from a display 106 consistent with the present disclosure. The illustrated example controller includes one or more processor(s) 804 (including one or more computer processors), a communications fabric 802, a memory 806 including, a random-access memory (RAM) 816 and a cache 818, a persistent storage 808, a communications unit 812 and I/O interfaces 814. It should be appreciated that FIG. 8 provides only an illustration of one embodiment and does not imply any limitations with regard to the environments in which different embodiments may be implemented. Many modifications to the depicted environment may be made.

As depicted, the controller 800 operates over the communications fabric 802, which provides communications between the computer processor(s) 804, the memory 806, the persistent storage 808, the communications unit 812, and the input/output (I/O) interface(s) 814. The communications fabric 802 may be implemented with an architecture suitable for passing data and/or control information between the processors 804 (e.g., microprocessors, communications processors, and network processors), the memory 806, the external devices 420, and any other hardware components within a system. For example, the communications fabric 802 may be implemented with one or more buses.

The memory 806 and the persistent storage 808 are computer readable storage media. In the depicted embodiment, the memory 806 includes a RAM 816 and a cache 818. In general, the memory 806 can include any suitable volatile or non-volatile computer readable storage media. Cache 818 is a fast memory that enhances the performance of processor(s) 804 by holding recently accessed data, and near recently accessed data, from RAM 816.

Computer readable program instructions for operating a function of a system in response to the sensor output(s) may be stored in the persistent storage 808, or more generally, any computer readable storage media, for execution by one or more of the respective computer processors 804 via one or more memories of the memory 806. Applications used in the system or devices, such as a word processing application, a mobile phone application, etc., and may also be stored in the persistent storage 808. The persistent storage 808 may be a magnetic hard disk drive, a solid-state disk drive, a semiconductor storage device, a flash memory, a read only memory (ROM), an electronically erasable programmable read-only memory (EEPROM), or any other computer readable storage media that is capable of storing computer readable program instructions or digital information.

The media used by persistent storage 808 may also be removable. For example, a removable hard drive may be used for persistent storage 808. Other examples include but are not limited to optical and magnetic disks, thumb drives, flash drives, and smart cards that are inserted into a drive for transfer onto another computer readable storage medium that is also part of persistent storage 808.

The communications unit 812, in these examples, provides for communications with other data processing systems or devices. In these examples, the communications unit 812 includes one or more network interface cards. The communications unit 812 may provide communications through the use of either or both wired and wireless communications links. In the context of embodiments of the present disclosure, the source of the various input data may be physically remote to the controller 800 such that the input data may be received, and the output similarly transmitted via the communications unit 812.

The I/O interface(s) 814 allows for receiving the sensor outputs from the display 106 (FIG. 1) and providing data representative of the sensor output(s) to the processors 804. The I/O interface(s) 814 may include, for example, one or more multiplexers for combining the sensor output(s) into an aggregate signal and pass the aggregate signal to the processors 804. The I/O interfaces 814 may optionally allow for input and output of data with other I/O devices 108 of the electronic device 102 and/or external devices and/or applications 112 external to the electronic device. For example, the I/O interface(s) 814 may provide a connection to other external I/O devices 108 such as a speaker, microphone, haptic device, a keyboard, a keypad, a printer, a digital camera, and/or other suitable devices. The other I/O devices 108 may also include portable computer readable storage media such as, for example, thumb drives, flash drives, portable optical or magnetic disks, and memory cards. Software and data used to practice embodiments of the present disclosure can be stored on such portable computer readable storage media and can be loaded onto persistent storage 808 via the I/O interface(s) 814.

Advantageously, and with continued reference to FIG. 1, embodiments of a display 100 having integrated sensors and pixels consistent with the present disclosure provide the ability to read and distinguish fingerprints of fingers in contact with the display 100, or in proximity to the display 100. Embodiments may for example, distinguish between an individual's separate fingerprints and/or the fingerprints of different people. In some embodiments, the fingerprints may be read at any location on the display 100 or over a large area of the display 100. In general, the sensors integrated in the display 100 may provide sensor output(s) representative of the features, e.g., ridges, associated with at least a portion of the fingerprint. In some embodiments, in response to the sensor outputs the controller(s) 104 may identify the features as being associated with a finger and operate a function of the system 100 in response thereto. In addition, or alternatively, the controller(s) 104 may compare features represented by the sensor output(s) with one or more fingerprint data files stored in memory to distinguish the fingerprint as being associated with a specific finger of a hand and/or a specific person and operate a function of the system 100 in response thereto.

FIG. 9 diagrammatically illustrates operation of a display 106c consistent with the present disclosure for reading a fingerprint. The display in FIG. 9 includes a base 602 and a cover layer 622, as described for example in connection with FIG. 6, and includes an example embodiment of an optics layer 620a as described in FIG. 6. For ease of illustration, FIG. 9 illustrates only a single pixel 902 and an associated sensor 904 for receiving light reflected from a specific location on a finger 906. The finger 906 in FIG. 9 is shown as in proximity to, but not touching, the top surface 624 of the display 106c, but operation would the same as described herein if the finger 906 was in contact with the top surface 624 of the display 106c.

As shown in FIG. 9, in some embodiments one or more subpixels 908, 910 of a pixel 902 in the display 106c may emit light 912 that passes through the optics layer 620 and through a top surface 624 of the cover layer 622. The light 912 emitted from the subpixels 908, 910 may contribute an image visible on the top surface 624 of the display 106c. The light 912 is reflected by the finger 906. At least a portion of the reflected light 914 passes back through the top surface 624 of the cover layer 622 and is imparted on the optics layer 620. For simplicity and ease of illustration, the figures herein illustrate light in diagrammatic form only and do not illustrate the refraction what would occur to the rays of light, e.g., light 912 and 914, at an interface between one index of refraction and another index of refraction.

In the illustrated example embodiment 106c, the optics layer 620a includes a translucent portion 916 for allowing light emitted 912 from the subpixels 908, 910 to pass therethrough and a sensor lens 918 positioned over the sensor 904. The sensor lens 918 includes an aperture 920 surrounded by an opaque portion 922. The aperture 920 may be configured to allow a portion of the light 914 reflected back to the display 106c to be imparted on the sensor 904, while the opaque portion 922 may block a remainder of the reflected light 914 from being imparted on the sensor 904. The aperture 920 may be configured for allowing light reflected from the finger 906 at a position directly above the sensor 904 to be imparted on the sensor 904. In this way, each sensor 904 may provide an associated sensor output representative of the features of a fingerprint of the finger 906 that are substantially directly above the sensor 904.

The sensor 904 thus provides a sensor output representative of a feature of a finger 906 at the location associated therewith. It is to be understood, that embodiments consistent with the present disclosure configured for reading a fingerprint would have a sufficient number of sensors positioned under the area of a finger 906 for providing a sufficient resolution of sensor output(s) to represent a fingerprint and/or distinguish the fingerprint from other fingerprints.

For example, microLED displays including integrated sensors consistent with the present disclosure, e.g., including sensors disposed in spaces between microLED pixels, e.g., as shown in FIG. 6, allow for a large number of sensors to be positioned under the area of a fingerprint. This provides sufficient resolution of sensor outputs to represent a fingerprint and/or distinguish a fingerprint from other fingerprints. MicroLED displays consistent with the present disclosure may also provide high image resolution and thus allow for integration of fingerprint detection into a high resolution display without a readily visible difference in the display resolution to a user. In some embodiments, for example, a microLED display configured for detecting a fingerprint may have a resolution of greater than 3,000 ppi, and especially greater than 4,000 ppi or greater than 5000 ppi. In some embodiments, the micro LED display may have a resolution of 10,000 ppi or more.

Each pixel in the location where the finger is located and in some embodiments each pixel in the entire display, may include an associated sensor adjacent thereto, e.g., in the space between pixels or in the 2-dimensional grid of the pixel. Embodiments including sensors disposed over the entire display (e.g., with each sensor being associated with a single pixel and/or a group of pixels) provide for increased comfort and ease of usability, as a user no longer has to position a single finger in the location of the one fingerprint sensor (either hardware-based or software-based).

Thus, embodiments provide for detecting and deciding between fingerprints on a display 106 in an easy and comfortable way. Embodiments therefore enable new interactions with an electronic device 102 and applications for the software of the electronic device 102. For example, in embodiments wherein the system 100 is configured to distinguish between an individual's separate fingerprints, the electronic device 102 may be programmed in a variety of ways, such as but not limited to a user's pinky finger touching the screen being associated with taking a picture, while a user's ring finger touching the screen is associated with controlling audio volume when moving up and down. Embodiments provide for having multiple functions for one input field for different fingers, such that different combinations of fingers and motions are used to interact with the display 106 and the software running on the electronic device 102 in a wide variety of combinations.

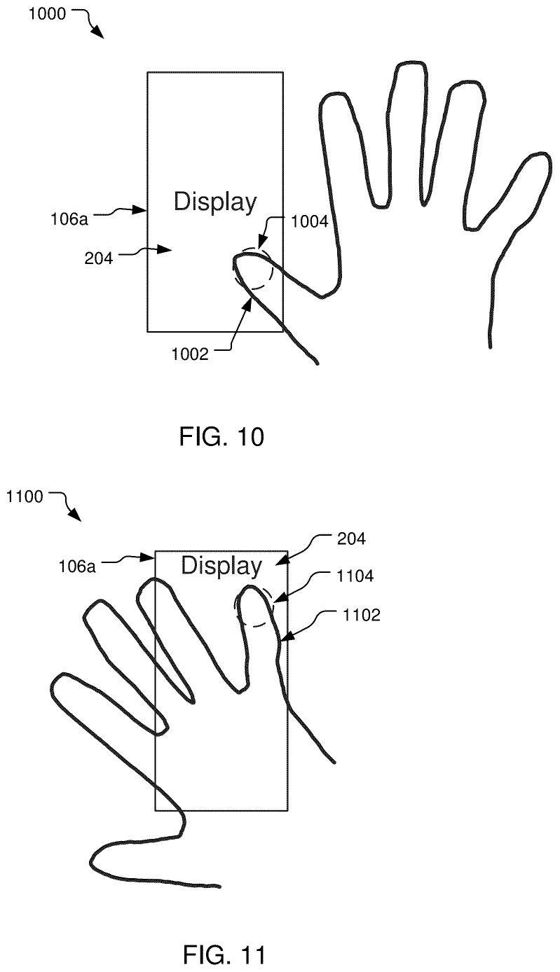

With reference to the display 106a in FIG. 2, for example, FIGS. 10-14 diagrammatically illustrate example embodiments consistent with the present disclosure wherein one or more fingers are used to cause the controller(s)104 to operate a function of the electronic device 102 or the system 100 (FIG. 1). FIG. 10 diagrammatically illustrates an example embodiment 1000 wherein the controller(s) 104 is configured to operate a function of an electronic device 102 or system 100, e.g., to unlock the display 106a, upon bringing one finger 1002 into contact with, or proximity to, the display 106a. In the illustrated example, a user's thumb 1002 contacts, or comes in proximity to, an area 1004 of the screen 204 of display 106a to unlock the display 106a from a locked mode. In some embodiments, sensors may be provided over the entire screen 204 of the display 106a so a single finger of a user touching, or in proximity to, anywhere on the display 106a will cause the controller(s) 104 to unlock the display 106a.

FIG. 11 diagrammatically illustrates an example embodiment 1100 wherein the controller(s) 104 is configured to operate a function of the electronic device 102 or the system 100 upon bringing a certain single finger 1102 into contact with, or in proximity to the display 106a. In the illustrated example, a user's pinky finger 1102 contacts, or comes in proximity to, an area 1104 of the screen 204 of the display 106a to operate a function, such as taking a picture using a camera of the electronic device 102. In some embodiments, the sensors may be provided over the entire screen 204 of the display 106a so a certain single finger of a user touching, or in proximity to, anywhere on the display 106a will cause the controller(s) 104 to operate an associated function.

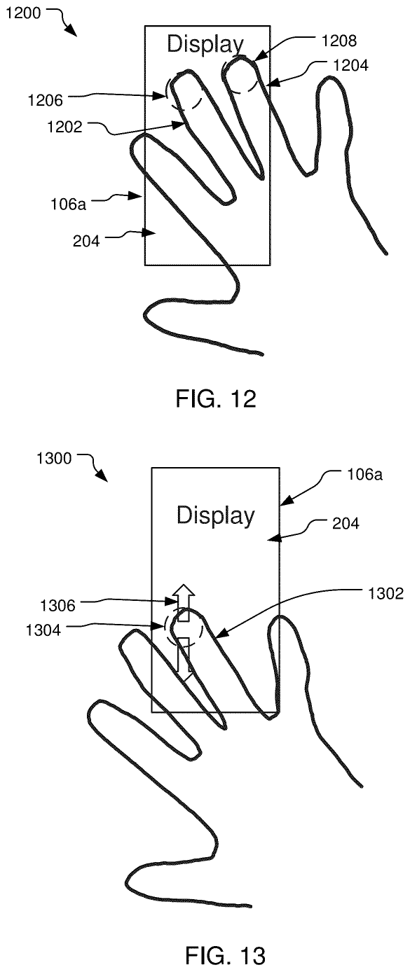

FIG. 12 diagrammatically illustrates an example embodiment 1200 wherein the controller(s) 104 is configured to operate a function of the electronic device 102 or the system 100 upon bringing multiple fingers 1202, 1204 into contact with, or in proximity to, the display 106a. In the illustrated example, a user's middle 1202 and ring 1204 fingers contacts, or comes in proximity to, areas 1206, 1208, respectively, of the screen 204 of the display 106a to operate a function, such as opening a music application and start playing the next music file. In some embodiments, the sensors may be provided over the entire screen 204 of the display 106a so multiple fingers of a user touching, or in proximity to, anywhere on the display 106a will cause the controller(s) 104 to operate a function of the electronic device 102 or the system 100.

FIG. 13 diagrammatically illustrates an example embodiment 1300 wherein the controller(s) 104 is configured to operate a function of the device upon movement of a finger 1302 relative to the display 106a. In the illustrated example, a user's index finger 1302 contacts, or comes in proximity to, an area 1304 of the screen 204 the display 106a and is moved from the area 1304, e.g., as indicated by the bi-directional arrow 1306, while remaining in contact with, or in proximity to, the display 106a. In response to movement of the user's finger 1302, the controller(s) 104 may operate a function. For example, the controller(s) 104 may operate a volume function of the device in response to movement of the finger 1302 where the volume of a speaker of the device is increased when the finger 1302 is moved upward relative to the display 106a and the volume of the speaker is decreased when the finger 1302 is moved downward relative to the display 106a, or vice-versa. In some embodiments, the sensors may be provided over the entire screen 204 of the display 106a so movement of a user's finger anywhere on, or in proximity to, the display 106a will cause the controller(s) 104 to operate a function of the electronic device 102 or the system 100.

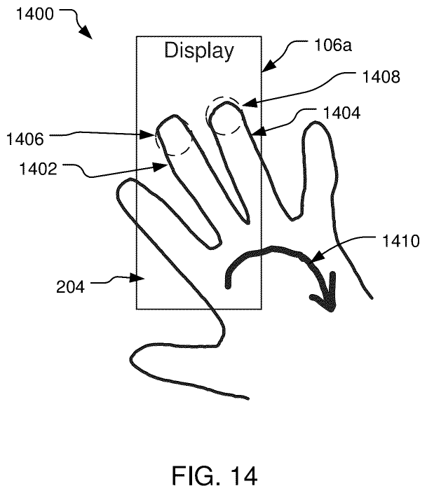

FIG. 14 diagrammatically illustrates an example embodiment wherein the controller(s) 104 is configured to operate a function of the electronic device 102 or the system 100 upon movement of multiple fingers relative to the display 106a. In the illustrated example, a user's middle 1402 and ring 1404 fingers contact, or come in proximity to, areas 1406, 1408, respectively, of the screen 204 of the display 106a and are rotated from the area, e.g., in the direction of arrow 1410, while remaining in contact with, or in proximity to, the display 106a. In response to movement of the user's fingers 1402, 1404 the controller(s) 104 may operate a function. For example, the controller(s) 104 may operate a zoom function of a camera of the electronic device 102 or the system 100 in response to movement of the fingers 1402, 1404 whereby the zoom is increased when the fingers 1402, 1404 are rotated in a first direction and decreased when the fingers 1402, 1404 are rotated in a second direction. Motion of the fingers 1402, 1404 in a different direction may operate a related function of the camera, such as the pan or tilt of the camera. In some embodiments, the sensors may be provided over the entire screen 204 of the display 106a so movement of a user's fingers 1402, 1404 anywhere on, or in proximity to, the display 106a will cause the controller(s) 104 to operate a function of the device.

Advantageously, some embodiments thus change the way a user interacts with a system, e.g., system 100 (FIG. 1), consistent with the present disclosure compared to a conventional device. Embodiments consistent with the present disclosure also allow for changes to the conventional devices, such as but not limited to removing hardware switches (e.g., switch(es) for volume control, switch(s) for power control, a wheel on a smart watch or other wearable device, etc.) or other input mechanisms (e.g., a fingerprint sensor), which additionally also change how a user interacts with an electronic device 102 and the software associated with the electronic device 102. Motions associated with one or more fingerprints replace the functionality associated with the removed hardware (e.g., one fingerprint and associated motions could replace the functionality of a current wheel on a smart watch). These changes may also impact how device manufacturers make such devices (e.g., removing the need to have mechanical switches integrated into the device) and how application creators create software for such devices (e.g., how a camera application is programmed to receive an instruction from the user to take a photo). Other modifications compared to a traditional device including the touch screen display are also possible. For example, a mobile phone in some embodiments includes one or more displays located on the back of the device, with fingerprint sensing and other functionality provided for via such displays, instead of, or in addition to, providing it on the front main display of the mobile phone.

Other advantages of embodiments will also be apparent. For example, embodiments may detect fingerprints and operate a function of the electronic device 102 or the system 100 to provide for increased security by enabling multiple fingerprint authentication and/or complete hand authentication. Embodiments may thus provide for secure identification for a variety of applications, including but not limited to identification cards, security systems (e.g., instead of a dedicated specialized handprint reader device, a simple display screen according to embodiments described herein may be used), payment cards and systems (e.g., a payment terminal display screen according to embodiments described herein may permit fingerprint sensing across the entire screen, which could be expanded to including multiple fingerprints/portions of the hand for authentication), and the like. In some embodiments, this may be combined with other technologies, such as vital sign sensors that enable anti-spoofing functionality and/or may be supported by additional sensors (such as but not limited to spectral sensing).

Embodiments consistent with the present disclosure also enable use of multiple user interfaces in a variety of ways. For example, with reference again to FIG. 1, when two or more people are using the same display 106 at the same time, the controller(s) 104 may distinguish between the individual people touching the display 106 because it is able to detect and distinguish the distinct fingerprints of each person and operate a function of the electronic device 102 or the system 100 in response thereto. This has advantages for applications in an office environment (e.g., operating a function to tracking which user makes which changes to a document) as well as other environments (e.g., operating a function enabling multiplayer games on a touch screen display, since the controller(s) 104 is able to determine which user is providing a given command).

The ability to distinguish between different users on the basis of their fingerprints also removes the need for the operating system of the electronic device 102 to have different login credentials associated with different user profiles. In other words, instead of a first person needing to provide their user ID and password to access their content on the electronic device 102, and then a second person must repeat those steps with their respective user ID and password to access their content, the system 100 or the electronic device 102 upon detecting the fingerprints of the first user would operate a function to provide the first user's content and, upon detecting the fingerprints of the second user would seamlessly shift to operating a function for providing the second user's content.

Further, embodiments are not limited to the descriptions provided herein, but in some embodiments are combined with other touch screen technology, such as but not limited to capacitive touch screen technology, to increase the precision of the detection of position.

In addition to, or in the alternative to, detecting fingerprints of user, embodiments consistent with the present disclosure may be configured to detect an orientation and/or the presence of a user's hand, finger, a fingernail or any other type of object that can interact with the display 102 of the electronic device 102 or the system 100 as an input device. For example, embodiments consistent with the present disclosure may be configured to detect the orientation and/or presence of objects such as, but not limited to, a stylus, a pen, a pen cap, and the like, including objects that are typically not detected by a conventional capacitive display.

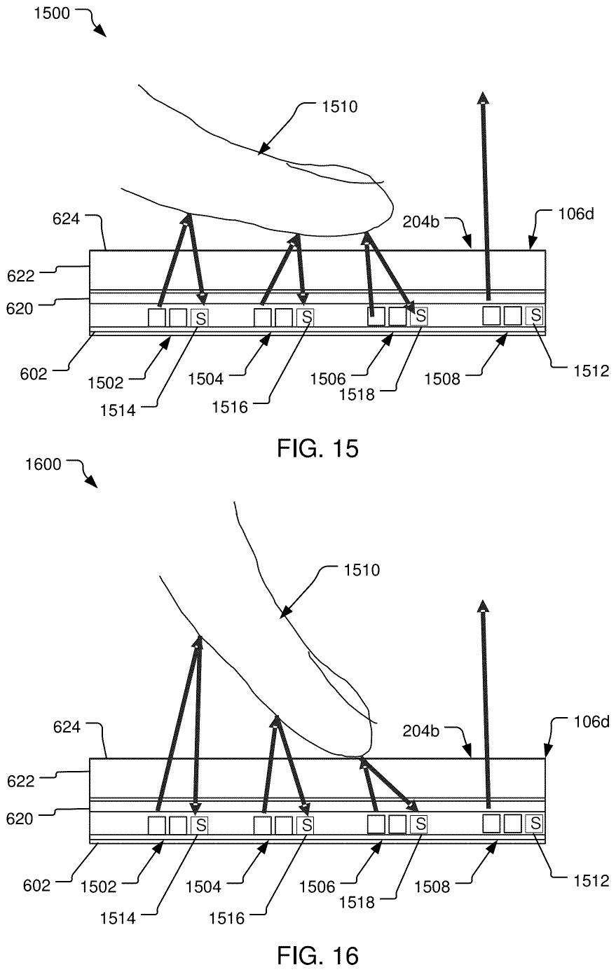

FIGS. 15 and 16, diagrammatically illustrate examples 1500, 1600 respectively, of a detecting the orientation of a finger in embodiments consistent with the present disclosure. For ease of illustration, FIGS. 15 and 16 illustrate a display 106d consistent with the present disclosure as including only four pixels 1502, 1504, 1506, 1508, it being understood that embodiments consistent with the present disclosure, especially microLED embodiments, may include pixels and sensors with a resolution of thousands of pixels-per-inch, including, for example, 10,000 or more ppi. In FIG. 15, a user's finger 1510 is in a relatively flat position with respect to the top surface 624 of the cover layer 622 of the display 106d and in FIG. 16, the user's finger 1510 is in a relatively inclined position with respect to the top surface 624 of the cover layer 622 of the display 106d. In the illustrated example, the top surface 624 of the cover layer 622 is the screen 204b of the display 106d. Although FIGS. 15 and 16 illustrate a single finger 1510 of a user, it is to be understood that embodiments may operate to detect the orientation of multiple fingers, fingernails and/or one or more other objects to be used as input for the electronic device 102 or the system 100 (FIG. 1).

As shown in FIG. 15, light emitted from pixel 1508 is not reflected back to the sensor 1512 associated with the pixel 1508. The sensor output from the sensor 1512 to the controller(s) 104 indicates that no object is positioned in contact or in proximity to the display106d at the location corresponding to the pixel 1508. Light emitted from the pixels 1502, 1504 and 1506 is reflected by the finger 1510 back to the sensors 1514, 1516, 1518, respectively, associated with the pixels 1502, 1504 and 1506. The sensors 1514, 1516, 1518 provide associated sensor outputs to the controller(s) 104 representative of the intensity of the reflected light imparted thereon.

In the illustrated embodiment, for example, the sensor output from the sensor 1516 may be greater than the sensor output of the sensor 1518, and the sensor output from the sensor 1518 may be greater than the sensor output from the sensor 1514. The controller(s) 104 may interpret these sensor outputs as indicating that the finger 1510 is in a relatively flat position with respect to the display with a slight incline at the tip of the finger 1510 and a larger incline at the rear of the finger 1510. In response to these sensor outputs, the controller(s) 104 may operate a function of the device and/or system, e.g., to enable writing in an application in lowercase letters.

As shown in FIG. 16, light emitted from the pixel 1508 is not reflected back to the sensor 1512 associated with the pixel. The sensor output from the sensor 1512 to the controller(s) 104 indicates that no object is positioned in contact or in proximity to the display 106d at the location corresponding to the pixel 1508. Light emitted from the pixels 1502, 1504, and 1506 is reflected by the finger 1510 back to the sensors 1514, 1516, 1518, respectively, associated with the pixels 1502, 1504, and 1506. The sensors 1514, 1516, 1518 provide associated sensor outputs to the controller(s) 104 representative of the intensity of the reflected light imparted thereon.

In the illustrated embodiment, for example, the sensor output from the sensor 1518 may be greater than the sensor output of the sensor 1516, and the sensor output from sensor 1516 may be greater than the sensor output from sensor 1514. The controller(s) 104 may interpret these sensor outputs as indicating that the finger 1510 is in a relatively inclined position with respect to the display 106d with the incline increasing from the tip of the finger 1510 to the rear of the finger 1510. In response to these sensor outputs, the controller(s) 104 may operate a function of the device and/or system, e.g., to enable writing in an application in uppercase letters.

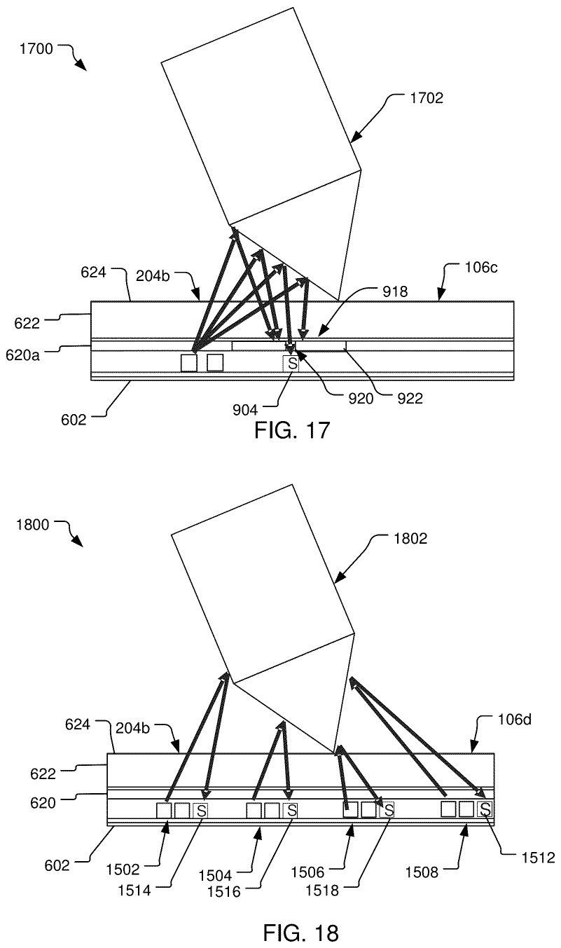

In some embodiments, a display including an optics layer with sensor lenses, e.g., as described in connection with FIG. 9, may be used in an electronic device 100 or a system 100 (FIG. 1) consistent with the present disclosure to detect the orientation of an object in contact with, or in proximity, to the display. FIG. 17, for example, illustrates an example embodiment 1700 configured for detecting the orientation of an object 1702 including a display 106c having an optics layer 620a with a sensor lens 918 having an aperture 920 positioned over a sensor 904. The aperture 920 may be configured to allow a portion of the light reflected back to the display 106c to be imparted on the sensor 904, while an opaque portion 922 of the sensor lens 918 blocks a remainder of the reflected light from being imparted on the sensor 904. The aperture 920 may be configured for allowing light reflected from the object 1702 at a position substantially directly above the sensor 920 to be imparted on the sensor 904. In this way, the sensor 920 may provide an associated sensor output representative of the position of portions of the object 1702 that are substantially directly above the sensor 920.

In addition to, or in the alternative to, detecting the orientation and/or fingerprint of an object in contact with, or in proximity to a display 106, embodiments consistent with the present disclosure may be configured to distinguish between different fingers of user, or multiple users and/or between different objects, without using fingerprint detection. For example, sensor outputs from different sensors in a display 106 consistent with the present disclosure will vary depending on the dimensions and other features of the object beyond the features of a fingerprint. In some embodiments, for example, when a relatively thin object (e.g., a stylus or a user's pinky finger) is detected the light reflected by the object is imparted on fewer sensors in the display 106 compared to when a relatively thick object (e.g., a user's thumb) is detected. In some embodiments, the sensor outputs may enable close range three-dimensional (3-D) sensing of objects in contact with, or in proximity to the display 106. The difference in the two-dimensional (2D) dimensions and/or 3D dimensions of the objects is represented by the sensor output(s).

In some embodiments, the controller(s) 104 may be configured to compare features represented by the sensor output(s) with one or more data files stored in memory to distinguish the objects and operate a function of the system in response thereto. For example, the objects may be distinguished as being a stylus, a pen, or as being a specific finger of a hand of a person. The controller(s) 104 may, for example, operate separate functions of the electronic device 102 or the system 100 in response to the identification of the object determined from the dimensions 2D and/or 3D dimensions of the object as represented by the sensor outputs.

Close range 3D sensing may be implemented using one or more NIR LED subpixels to provide operation that is invisible to a user. Use of 3D sensing also permits embodiments to detect the orientation of an object relative to the display 106 and then enable one or more additional functions. For example, in some embodiments, the sensor output(s) may be representative of a small tilt or other change in orientation of an object, e.g., a fingernail, in one direction. In response, the controller(s) 104 may operate a function of the device or system to change the type of letter using in a writing application (lowercase to capital and back), while in some embodiments, tilting (or orientating) the fingernail in a different direction cause the controller(s) 104 to operate a function to create a different line or a line with a different color.

In some embodiments, the sensor outputs(s) may be representative of the direction from which the display 106 is touched or approached. In response, the controller(s) 104 may operate a function depending on the direction. For example, touching the display 106 with a fingernail from the right hand side of a smart watch may cause the controller(s) 104 to operate a function to decrease the volume of music being played from the smart watch, while touching a display 106 with a fingernail from the left hand side of the smart watch may cause the controller(s) 104 to operate a function to advance to the next song in a music application. In this way, embodiments both remove the need for additional input devices like a stylus while also adding new functionality and applications by detecting the dimensions, orientation and/or tilt of one or more input devices.

Some embodiments consistent with the present disclosure may implement one or more illumination patterns of the pixels in the display 106 to perform close range 3D sensing of objects, e.g., with or without NIR LEDs. For example, the controller(s) 104 may be configured to illuminate certain pixels or groups of pixels or subpixels in of the display 106 in illumination patterns. The illumination patterns of pixels or groups of pixels may be the same or different patterns and may be modulated.

FIG. 18, for example, diagrammatically illustrates an example embodiment 1800 for using illumination patterns of different pixels or groups of pixels consistent with the present disclosure. For ease of illustration, FIG. 18 illustrates the display 106 as including only four pixels 1502, 1504, 1506, 1508, it being understood that embodiments consistent with the present disclosure, especially microLED embodiments, may include pixels and sensors with a resolution of thousands of pixels-per-inch, including, for example, 10,000 or more ppi.

As shown, in the illustrated embodiment light emitted from the pixels 1502, 1504, 1505, 1506, 1508 is reflected by an object 1802 back to the sensors 1514, 1516, 1518, 1512, respectively, associated with the pixels 1502, 1504, 1505, 1506, 1508. The controller(s) 104 may be configured to cause emission of light from the pixels 1502, 1504, 1505, 1506, 1508 or groups of the pixels in a pattern. For example, the controller(s) 104 may be configured to drive pixel 1502 and then turn off pixel 1502 and drive pixel 1508 in a continuous pattern. In another embodiment, the controller(s) 104 may be configured to drive pixels 1502 and 1508 and then turn off pixels 1502 and 1508 and drive pixels 1504 and 1506 in a continuous pattern.

Driving the pixels 1502, 1504, 1505, 1506, 1508 in illumination patterns allows for close range 3D sensing and for detection of changes in the orientation of the object 1802, e.g., panning or tilting of the object, or motion of an object 1802. The controller(s) 104 may be configured to operate a function of the device or system in response to the sensed 3D dimensions as represented by the sensor output(s) and/or in response to the changes in orientation or motion of represented by the sensor outputs(s) and/or in response to combinations thereof. During the process and/or after already recognizing an input device (e.g., using illumination), embodiments include shrinking or otherwise changing the illumination area of the display 106 to a certain size (e.g., a minimum needed area) around the input device.

Numerous embodiments will be apparent in light of this disclosure. According to one aspect of the disclosure, there is provided an apparatus including a display and a controller. The display includes a plurality of pixels, each of the plurality of pixels being configured to emit an associated light output through a screen of the display to produce an image visible to a user, and a plurality of sensors, each of the plurality of sensors being configured to detect a reflected portion of the associated light output of at least one associated one of the plurality of pixels and provide an associated sensor output in response to the reflected portion, the reflected portion being reflected by an object and back into the screen of the display. The controller is configured to operate a function of the apparatus in response to the associated sensor outputs of the plurality of sensors.

According to another aspect of the disclosure, each pixel of the display is associated with an associated one of the plurality of sensors whereby the plurality of sensors are positioned to detect the reflected portion reflected by the object positioned over any location of the screen.

According to another aspect of the disclosure, the plurality of sensors are positioned to detect the reflected portion reflected by the object positioned over at least 30% of the screen.

According to another aspect of the disclosure, the plurality of sensors are disposed in spaces between the pixels.

According to another aspect of the disclosure, each of the plurality of pixels include subpixels arranged in a two-dimensional grid, and each of the plurality of sensors is disposed within the two-dimensional grid of an associated one of the plurality of pixels.

According to another aspect of the disclosure, each of the plurality of sensors is associated with a single one of the plurality of pixels.

According to another aspect of the disclosure, each of the plurality of pixels includes at least one subpixel configured to emit non-visible light.

According to another aspect of the disclosure, the plurality of pixels and the plurality of sensors are provided on a base.

According to another aspect of the disclosure, each of the plurality of pixels are microLED pixels having a resolution on the display of at least 3,000 pixels-per-inch.

According to another aspect of the disclosure, each of the plurality of pixels are microLED pixels having a resolution on the display of at least 3,000 pixels-per-inch and each of the plurality of sensors is associated with a single one of the plurality of pixels, and wherein the plurality of sensors are positioned to detect the reflected portion reflected by the object positioned over at least 30% of the screen.

According to another aspect of the disclosure, the object is a finger and the sensor outputs are representative of at least a portion of a fingerprint of the finger, and wherein the controller is configured to identify the fingerprint and operate the function of the apparatus in response to identification of the fingerprint.

According to another aspect of the disclosure, the sensor outputs are representative of an orientation of the object with respect to the display, and wherein the controller is configured to operate the function of the apparatus in response to the orientation of the object.

According to another aspect of the disclosure, the sensor outputs are representative of at least one dimension of the object, and wherein the controller is configured to operate the function of the apparatus in response to the at least one dimension of the object.

According to another aspect of the disclosure, the function of the apparatus is a function to unlock a display from a locked mode, a function to take a picture using a camera of the apparatus, a function to launch an application on the apparatus, a function to change the volume of a speaker of the apparatus, or a function to change a zoom of the camera of the apparatus.

According to another aspect of the disclosure, there is provided a machine implemented method for operating a function of an apparatus having a display, the method including: driving pixels of the display to produce an image; receiving sensor outputs from sensors integrated in the display, each of the sensor outputs being representative of light emitted by one or more pixels and reflected by an object; determining a feature of the object in response to the sensor outputs; and operating the function of the apparatus in response to determining the feature.

According to another aspect of the disclosure, the object is a finger and the feature is at least a portion of a fingerprint of the finger.

According to another aspect of the disclosure, the feature is an orientation of the object with respect to the display.

According to another aspect of the disclosure, the feature is at least one dimension of the object.

According to another aspect of the disclosure, there is provided a machine readable storage medium storing computer readable program instructions which when executed cause at least one processor to perform a method including: driving pixels of the display to produce an image; receiving sensor outputs from sensors integrated in the display, each of the sensor outputs being representative of light emitted by one or more pixels and reflected by an object; determining a feature of the object in response to the sensor outputs; and operating the function of the apparatus in response to determining the feature.

According to another aspect of the disclosure, the object is a finger and the feature is at least a portion of a fingerprint of the finger.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

It is, therefore, to be understood that the foregoing embodiments are presented by way of example only and that, within the scope of the appended claims and equivalents thereto, the invention may be practiced otherwise than as specifically described and claimed. The present invention is directed to each individual feature, embodiment, system, article, material, kit, and/or method described herein. In addition, any combination of two or more such features, embodiments, systems, articles, materials, kits, and/or methods, if such features, systems, articles, materials, kits, and/or methods are not mutually inconsistent, is included within the scope of the present invention.

The present disclosure may be a system, a method, and/or a computer program product. The system or computer program product may include one or more non-transitory computer readable storage media having computer readable program instructions thereon for causing a processor to carry out aspects of the present disclosure.

The methods and systems described herein are not limited to a particular hardware or software configuration and may find applicability in many computing or processing environments. The methods and systems may be implemented in hardware or software, or a combination of hardware and software. The methods and systems may be implemented in one or more computer programs, where a computer program may be understood to include one or more computer readable program instructions. The computer program(s) may execute on one or more programmable processors and may be stored on one or more non-transitory storage medium readable and executable by the processor (including volatile and non-volatile memory and/or storage elements), one or more input devices, and/or one or more output devices. The processor thus may access one or more input devices to obtain input data and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in embodiments, a client-server model as needed. Accordingly, the methods and systems may utilize multiple processors and/or processor devices, and the computer readable program instructions may be divided amongst such single-or multiple-processor/devices.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s) or smart cellphone(s), laptop(s), handheld computer(s), watch(es), television(s), security monitor(s)or another device(s) capable of being integrated with a processor(s) that may operate as provided herein. Accordingly, the devices provided herein are not exhaustive and are provided for illustration and not limitation.

Aspects of the present disclosure may be described herein with reference to flowchart illustrations and/or block diagrams of methods, apparatus (systems), and computer program products according to embodiments of the disclosure. It will be understood that step described herein and each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts described herein and/or specified in the flowchart and/or block diagram block or blocks. These computer readable program instructions may also be stored in one or more non-transitory computer readable storage media that can direct a computer, a programmable data processing apparatus, and/or other devices to function in a particular manner, such that the one or more non-transitory computer readable storage media having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operations to be performed on the computer, other programmable apparatus, or other device to produce a computer implemented process, such that the instructions which execute on the computer, other programmable apparatus, or other device implement the functions/acts described herein or specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each step described herein and each block in the flowchart or block diagrams may represent a module, a segment, or a portion of instructions, which includes one or more executable instructions for implementing the specified logical function(s). In some alternative implementations, the functions described herein and/or noted in the blocks may occur out of the order described or noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer readable program instructions.

References to “microprocessor” or “processor” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible non-transitory memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. The term “coupled” as used herein refers to any connection, coupling, link or the like by which signals carried by one system element are imparted to the “coupled” element. Such “coupled” devices, or signals and devices, are not necessarily directly connected to one another and may be separated by intermediate components or devices that may manipulate or modify such signals. Likewise, the terms “connected” or “coupled” as used herein in regard to mechanical or physical connections or couplings is a relative term and does not require a direct physical connection. Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements. The phrase “at least one of A and B” should be understood to mean “only A, only B, or both A and B.”

Spatially relative terms, such as “beneath,” below,” upper,” “lower,” “above”, “left”, “right” and the like may be used herein for ease of description to describe one element or feature's relationship to another element(s) or feature(s) as illustrated in the drawings. These spatially relative terms are intended to encompass different orientations of the device in use or operation in addition to the orientation shown in the drawings. For example, if the device in the drawings is turned over, elements described as “below” or “beneath” other elements or features would then be oriented “above” the other elements or features. Thus, the exemplary term “below” may encompass both an orientation of above and below. The device may be otherwise oriented (rotated 90 degrees or at other orientations) and the spatially relative descriptors used herein interpreted accordingly.

Although the terms “first,” “second,” “third” etc. may be used to describe various elements, components, regions, layers and/or sections, these elements, components, regions, layers and/or sections are not to be limited by these terms as they are used only to distinguish one element, component, region, layer or section from another element, component, region, layer or section. Thus, a first element, component, region, layer or section could be termed a second element, component, region, layer or section without departing from the scope and teachings of the present invention.

Although the methods and systems have been described relative to a specific embodiment thereof, they are not so limited. Many modifications and variations may become apparent in light of the above teachings. Many additional changes in the details, materials, and arrangement of parts, herein described and illustrated, may be made by those skilled in the art.

What is claimed is:

1. An apparatus comprising:
a display, the display comprising:
a plurality of pixels, each of the plurality of pixels being configured to emit an associated light output through a screen of the display to produce an image visible to a user, and
a plurality of sensors, each of the plurality of sensors being configured to detect a reflected portion of the associated light output of at least one associated one of the plurality of pixels and provide an associated sensor output in response to the reflected portion, the reflected portion being reflected by an object and back into the screen of the display; and
at least one controller configured to operate a function of the apparatus in response to the associated sensor outputs of the plurality of sensors.

2. The apparatus of claim 1, wherein each pixel of the display is associated with an associated one of the plurality of sensors whereby the plurality of sensors are positioned to detect the reflected portion reflected by the object positioned over any location of the screen.

3. The apparatus of claim 1, wherein the plurality of sensors are positioned to detect the reflected portion reflected by the object positioned over at least 30% of the screen.

4. The apparatus of claim 1, wherein the plurality of sensors are disposed in spaces between the pixels.

5. The apparatus of claim 1, wherein each of the plurality of pixels comprise subpixels arranged in a two-dimensional grid, and each of the plurality of sensors is disposed within the two-dimensional grid of an associated one of the plurality of pixels.

6. The apparatus of claim 1, wherein each of the plurality of sensors is associated with a single one of the plurality of pixels.

7. The apparatus of claim 1, wherein each of the plurality of pixels comprises at least one subpixel configured to emit non-visible light.

8. The apparatus of claim 1, wherein the plurality of pixels and the plurality of sensors are provided on a base.

9. The apparatus of claim 1, wherein each of the plurality of pixels are microLED pixels having a resolution on the display of at least 3,000 pixels-per-inch.

10. The apparatus of claim 1, wherein each of the plurality of pixels are microLED pixels having a resolution on the display of at least 3,000 pixels-per-inch and each of the plurality of sensors is associated with a single one of the plurality of pixels, and wherein the plurality of sensors are positioned to detect the reflected portion reflected by the object positioned over at least 30% of the screen.

11. The apparatus of claim 1, wherein the object is a finger and the sensor outputs are representative of at least a portion of a fingerprint of the finger, and wherein the controller is configured to identify the fingerprint and operate the function of the apparatus in response to identification of the fingerprint.

12. The apparatus of claim 1, wherein the sensor outputs are representative of an orientation of the object with respect to the display, and wherein the controller is configured to operate the function of the apparatus in response to the orientation of the object.

13. The apparatus of claim 1, wherein the sensor outputs are representative of at least one dimension of the object, and wherein the controller is configured to operate the function of the apparatus in response to the at least one dimension of the object.

14. The apparatus of claim 1, wherein the function of the apparatus is a function to unlock a display from a locked mode, a function to take a picture using a camera of the apparatus, a function to launch an application on the apparatus, a function to change the volume of a speaker of the apparatus, or a function to change a zoom of the camera of the apparatus.

15. A machine implemented method for operating a function of an apparatus having a display, the method comprising:
driving pixels of the display to produce an image;
receiving sensor outputs from sensors integrated in the display, each of the sensor outputs being representative of light emitted by one or more pixels and reflected by an object;
determining a feature of the object in response to the sensor outputs; and
operating the function of the apparatus in response to determining the feature.

16. The machine implemented method of claim 15, wherein the object is a finger and the feature is at least a portion of a fingerprint of the finger.

17. The machine implemented method of claim 15, wherein the feature is an orientation of the object with respect to the display.

18. The machine implemented method of claim 15, wherein the feature is at least one dimension of the object.

19. A machine readable storage medium storing computer readable program instructions which when executed cause at least one processor to perform a method comprising:
driving pixels of the display to produce an image;
receiving sensor outputs from sensors integrated in the display, each of the sensor outputs being representative of light emitted by one or more pixels and reflected by an object;
determining a feature of the object in response to the sensor outputs; and
operating the function of the apparatus in response to determining the feature.

20. The machine readable storage medium of claim 19, wherein the object is a finger and the feature is at least a portion of a fingerprint of the finger.
